(19) United States
(12) Patent Application Publication
(10) Pub. No.: US 2026/0027901 A1
(43) Pub. Date: Jan. 29, 2026

(54) Apparatus and Method for Sensory Adjustments in Electric Vehicles

(71) Applicant: Vincent Loccisano, Wellesley, MA (US)

(72) Inventor: Vincent Loccisano, Wellesley, MA (US)

(21) Appl. No.: 18/783,603

(22) Filed: Jul. 25, 2024

(51) Int. Cl. B60K 35/28; B60K 35/21; B60K 35/23; B60K 35/25; B60K 35/26

(52) U.S. Cl. CPC B60K 35/28; B60K 35/211; B60K 35/23; B60K 35/25; B60K 35/26

(57) ABSTRACT

A method and apparatus enables modifying the electronic controls of EVs to mimic the sensory experience of driving a performance ICE car. The method and apparatus creates a sensory “virtual cockpit” with both electronic and mechanical enhancements for a sensory experience. By downloading and implementing the method and apparatus, one may mimic, for example, the vehicle dynamics, performance horsepower, torque curves, suspension settings, oversteer and understeer behavior, steering-wheel inputs, cabin sound, subtle cabin vibrations, and audio/visual cues via a graphical user interface. These simulations replicate, in an electric vehicle, the various aspects of an ICE vehicle to mimic the whole experience of driving various ICE performance vehicles.

### TECHNICAL FIELD

This apparatus and method relates to methods, circuits, or devices for controlling the electronic visual display of electrically-propelled vehicles for control of the vehicle or its driving motor to achieve a desired performance; information or communication technologies improving the operation of electric vehicles; arrangements of instruments for and aspects of display of information in a vehicle; non-manual adjustments, e.g. with electrical operation with logic circuits and with logic circuits using sensors or detectors for adapting control systems specially adapted for electric vehicles.

### BACKGROUND OF THE INVENTION

While electric vehicles (EVs) and hybrid vehicles offer environmental benefits by reducing greenhouse-gas emissions and air pollution, some drivers find the driving experience to be unsatisfactory because there is little sensory feedback of the kind they are used to in traditional internal-combustion-engine (ICE) vehicles. Some consumers express a preference for the sound and vibration associated with traditional internal-combustion-engine (ICE) vehicles, whether out of nostalgia, a perception of a more engaging driving experience, or lack of feedback about vehicle performance in EVs.

Automobile electronics, including computers, electrical cables, and software protocols, are together known as a controller-area network (CAN), or CANbus. A CAN is a vehicle's main computer system. Through the CANbus, data travels through the system to the many subsystems such as those controlling the engine, the transmission, doors, windows, and other subsystems. Each of these subsystems is controlled by an electronic control unit (ECU). Current EVs may have fifty or more ECUs, each able to sense signals indicating, for example: acceleration at various angles; voltage; pressure; braking; vehicle roll and yaw; steering angle; temperature, and other variables. The CANbus routes signals from sensors to computers as communicated by each ECU. An ECU can monitor voltage used by a subsystem and communicate that information through the CANbus to actuate, for instance, stopping a power-sliding door from closing on a passenger's limb, or adjusting a fuel injector's performance.

Adding to or changing a vehicle's electronic features once required extensive wiring. With the development of CAN in the last forty years, feature development (such as adding passenger-controlled climate options) has become physically easier because each new feature can now be added by programming the new computer code into the CAN. Now, all vehicle features as well as vehicle diagnostics are controlled via CAN, which uses a standardized protocol called OBD-II. New features can be integrated into an EV by developing and uploading an algorithm into the vehicle's CAN.

Vehicle computer networks are now evolving to work with other network protocols, including Local Interconnect Networks (LIN) and FlexRay, which are network protocols designed for vehicles, as well as Ethernet.

Modem EV vehicles have software components allowing the suspension, driveline performance, and driver experience to be customizable for a variety of applications. For example, a modern EV may have an “eco” mode that offers greater distance range; a comfort mode that tunes the suspension to be compliant and smooth; and a high-performance mode that offers the best traction, acceleration and cornering performance.

Modem electric drivetrains offer high horsepower and near-instantaneous torque, depending on the size of the car's batteries and number of electric motors. Some EVs have four electric motors, one at each wheel, enabling advanced dynamic control such as torque and power vectoring. Because of this, previously impossible levels of performance, acceleration and speed, as well as control over individual systems, are now available.

The multiple motors of an EV's subsystems enable fine-tuning of vehicle dynamics and performance under braking, acceleration and cornering. Some EVs offer four-wheel steering, with both the front and rear wheels selectively steering in sometimes-different directions. Other controls, including steering ratio, brake-pedal response, accelerator response, horsepower and torque curves are readily changed in a modern EV, simply because they require no more than electronic inputs into the drivetrain and new algorithms downloaded to the vehicle CAN. Shock absorbers and dampers that are electronically controlled can be easily reconfigurable settings. Current computing technology allows implementing variable steering ratios and vehicle performance such as understeer and oversteer.

Multiple electric motors, coupled with brakes with gyroscopic sensors, as well as a variety of other additional existing inputs, allow a vehicle chassis to be actively tuned or reprogrammed. This is possible in existing EVs and will be even more possible as these features are increasingly integrated into the development of future EVs.

Additionally, these modem and near-future electric vehicles have greatly engineered vehicle dynamics, including highly customizable and tunable shock absorbers, roll bars, and dampers. Advanced vehicles also enable remotely adjustable settings for caster, camber, and ride height.

Modem and future EVs will soon enable finely tunable driver electronic inputs. Accelerators and brakes will no longer be physically connected to the corresponding systems of the vehicle; instead they will be electronic inputs controlled by a computer and ultimately delivered to the wheels. Modem EVs also require no physical gear-changing because these vehicles don't need a clutch or a manual transmission. Additionally, steering will be electronically rather than mechanically directed. For example, the Tesla Cyber Truck is the first mass-produced EV in which the steering wheel is a steer-by-wire system that is not rigidly connected to the turning wheels of the vehicle.

The placement of an ICE performance vehicle's engine affects the vehicle's feel and handling. Engine placement in an ICE vehicle depends on interior space, traction, steering dynamics, acceleration, braking performance and other aspects. In a front-engine car, the most common in commuter passenger ICE vehicles, the engine is over the front axle. With this there is little chance of understeer, but a risk of oversteer, which, by comparison, is easily corrected. This architecture offers ample interior space for passengers. Front-wheel-drive, front-engine vehicles do not require complex mechanical drive trains. The configuration is cost-effective and offers ease of access for service and maintenance. Front-engine cars come with drawbacks of a high center of gravity, which leads to body roll and inferior high-speed handling.

In mid-engine ICE vehicles, the engine is behind the driver's seat. The BMW i8, Ferrari 488 GTB, Lamborghini Aventador and Porsche 718 Boxter Cayman have mid-engine placement. Generally, centered weight distribution provides superior handling and a low center of gravity that results in excellent high-speed handling and braking performance. Drawbacks to mid-engine ICE vehicles include a lack of room for rear passenger seats and a complex, expensive design for service and maintenance. A lack of mass in front of the driver poses safety concerns. Unlike with front-engine cars, airflow for removing heat from the engine is complex.

A rear-engine vehicle has rear-wheel drive and its engine mounted above the rear axle. A Porsche 911 is a well-known ICE rear-engine performance vehicle. Rear-engine vehicles offer excellent handling from superior rear-wheel traction, which provides favorable initial acceleration, but they are prone to oversteer as the front wheels are not powered, and do not have sufficient weight on them. Maintenance and repairs are more expensive than front-engine vehicles and the cooling system is complex.

A Heads-Up Display (HUD) is a transparent image projected onto a windshield of a vehicle, presenting data without requiring a driver to look away from the road. The origin of the name HUD stems from its earliest application in aircraft where a transparent display in front of the wind screen enabled easier viewing. A HUD obviates the necessity of refocusing between the landscape and the near surface of the interior dashboard.

Holography is a technique that enables a wavefront to be recorded and later reconstructed. A hologram is a recording of an interference pattern that can reproduce a 3D light field using diffraction.

Liquid Crystal Displays (LCD) are electronically modulated optical devices that use light-modulating properties of liquid crystals combined with polarizers.

Innovations in the state of the art delve into haptic feedback systems integrated into the steering wheel or pedals to simulate gear changes or engine response. While these innovations address specific aspects of the driving experience, they lack a comprehensive approach to replicating the full sensory experience of an ICE performance vehicle.

Vibration is commonly produced electronically with DC eccentric rotating mass (ERM) motors. ERM motors are typically DC motors with a non-concentric weight on the motor shaft. Spinning the DC motor moves the weight and creates a vibration as the weight rotates on the shaft's central axis. One skilled in the art understands that various mechanisms may be used to cause vibration; a generic term for such devices is vibratory actuator. Vibration may also be simulated by a subwoofer that is capable of producing nondirectional vibratory bass sounds. A subwoofer/vibratory actuator may be placed anywhere in the vehicle to provide a vibratory experience equally to any passenger in the vehicle.

Patents and products in the current state of the EV art mimic some of the performance characteristics and exterior sounds of internal-combustion-engine cars. Controls and customizability of the experience are limited and may not be feasible for all vehicle makes and models.

Other inventions delve into haptic feedback systems integrated into the steering wheel or pedals to simulate gear changes or engine response. While these patents address specific aspects of the driving experience, they lack a comprehensive approach to replicating the full sensory experience of an ICE.

All of these subsystems can be electronically operated through a central control that can be modified by a driver, but the loss of mechanical sound and feel may disappoint driving enthusiasts, who may come to view their EV as an appliance rather than a car.

A customizable and adaptable system that caters to the preferences of car enthusiasts would offer a responsive, sensory experience like that of performance cars.

### SUMMARY OF THE INVENTION

A method and apparatus enables modifying the electronic controls of EVs to mimic the sensory experience of driving a performance ICE car by gathering information from at least one sensor in the EV—either a factory-installed sensor, or after-market installed sensor—and responding to the driver with audio or visual communication that mimics an ICE-driving experience. A sensor may include a common sensor, a camera, a speedometer, or any gauge. The method and apparatus creates a sensory “virtual cockpit” with both electronic and mechanical enhancements for a sensory experience. By downloading and implementing the method and apparatus, one may replicate, for example, the vehicle dynamics, performance horsepower, torque curves, suspension settings, oversteer and understeer behavior, steering-wheel inputs, cabin sound, subtle cabin vibrations, and audio/visual cues via a graphical user interface. These simulations replicate the various gauges of an ICE vehicle to mimic the entire experience of driving an ICE performance car of choice.

The method and apparatus's algorithm may be downloaded into any of an EV's ECUs, CAN, LIN, or Ethernet platform to simulate aspects of an ICE. The method and apparatus creates a virtual cockpit that simulates a particular ICE vehicle, toggling between EV and ICE experience, enabling, for example, shifter friction and clutch take-up and pressure.

In one embodiment, a vehicle manufacturer maps its factory-supported, brand-specific system commands to the algorithms of the method and apparatus to render the EV an immersive ICE simulation that is layered over EV technology. Features and functions of factory-supported, brand specific ICE vehicle systems are mapped to create a referenced internal combustion-engine vehicle dynamic definition. For example, a driver interested in replicating the experience of driving a 1960s Jaguar might choose to purchase the manufacturer's modified system commands specific to a 1960s Jaguar, or might choose to use the method and apparatus to alter the factory-provided CAN to simulate that experience. Features and functions that define the referenced ICE vehicle dynamic definition may include road feel, suspension component performance and feel, visual appearance of dashboard gauges, switches and controls, ICE vehicle sounds, or engine and transmission control and vibration.

In a separate iteration, a driver may choose an aftermarket, downloadable “vehicle pack” or modification set that employs the apparatus and method to make the modifications. Here an EV driver has additional control over each input. For example, they may want to “shift” gears without employing a clutch. In this case the driver would turn off a “use clutch input” command, and the EV would handle virtual shifting without the use of a virtual clutch, replicating an act of smooth shifting.

A driver wishing to enable automatic double-clutching or rev-matching between gear changes, but not wanting to do it themselves using a clutch and throttle, would choose an input (a button or other device) to achieve that end.

In each iteration, driver inputs are mapped to existing controls that output those replicating the model of choice. Specifically, for example, the driver might experience the act and haptic experience of shifting gears, with a shifting device and clutch pedal. In some iterations, the shifting device and clutch pedal are added as an after-market accessory. The clutch pedal may be programmed to mimic the sound and effect on the motor shifting between gears.

One skilled in the art understands that a sound system may be configured to appropriate the sound of an ICE transmission shifting through gears at various speeds.

The stiffness and friction point location of a specific ICE clutch, for example, as well as the stiffness and response of a brake pedal may be mimicked. In one embodiment a user can configure a number of features in combination from various ICE performance vehicles. For example a user may want to try a mid-engine weight balance with a racing clutch pedal and a shift lever with slightly softer suspension than most performance vehicles.

Performance ICEs have unique clutch designs and unique clutch-pedal actions. Some sports cars have heavier clutches intended for aggressive shifting. This results in a clutch pedal that is harder or “heavier” to push. In other performance ICE cars, particularly sports models, a clutch pedal may have a higher friction point than a daily commuter car. In some embodiments of the apparatus and method, aspects like the weight of a virtual clutch pedal, the location along the clutch pedal, and the stroke of the friction point can be adjusted through an electronic resistance-change, indicated by driver input, to accurately represent an ICE vehicle of the driver's choosing. Drivers interested in a particular performance car experience might choose either a stiff-clutch or a lighter-touch effect. A driver may choose, for example, between a street version of a performance ICE or a track-ready version with a heavier clutch and higher friction point. In some embodiments a user may alter details of the downloaded software package. For example, a user may modify parameters of the software to turn off or modify a function such as the use of a clutch pedal, the volume of the engine sound, or other aspects.

One embodiment creates a virtual clutch and manual transmission in which the shifter is employed as an aftermarket accessory that is either offered by the manufacturer or built into the EV, offering alternative operational effects in day-to-day driving. The apparatus and method enables various modes: while switched to a normal, “EV-driving mode,” the embodiment's EV shifter is used to control the interior climate system; when switched to “replica mode,” it simulates the changing of virtual gears. Similarly, the embodiment simulates the haptic experience of a clutch pedal, with electrical signals input to the vehicle's CAN to create a feel of a virtual clutch pedal, adjustable by electronic resistance changes through the inputs into the embodiment's driver interface. A mis-shift is met with, for example, the sound of grinding gears and the feeling of a bucking vehicle. Additionally, in this embodiment, a driver could virtually “stall” the vehicle by letting out the virtual clutch too quickly, causing the motor to imitate the feel of a stall while maintaining a safe speed.

The method and apparatus enables reconfiguration of modern EV components to change vehicle dynamic parameters. For example, shifting the batteries even a few inches fore or aft of a vehicle's center changes the static vehicle weight balance from a front-bias to a center-bias or a rear-bias, mimicking the configuration of performance vehicles. Other aspects of a car that are influenced by weight balance include traction, steering dynamics, acceleration and braking, any of which can be altered by the system and apparatus.

In some embodiments, a battery compartment is mounted on linear-motion bearings and shafts coupled with mechanical actuators to move the batteries fore or aft of their original location to mimic a front-, center- or rear-engine vehicle. Shifting the battery weight toward the front of the vehicle may also improve traction to the front wheels and prevent understeer, for example.

An apparatus includes a battery-mounting platform that may be moved by linear actuators. The platform is configured to shift the location of a battery platform so that the weight distribution of the vehicle may be centrally located in the vehicle or may be shifted fore or aft of center. Shifting the battery platform results in a driving experience of a front-engine, mid-engine or rear-engine performance ICE vehicle.

Shifting battery weight toward the center of the vehicle can mimic the performance of mid-engine performance vehicles such as the Ferrari 488 GTB or Porsche 718 Boxster Cayman. Equal weight distribution between all four wheels provides superior handling and equal traction between all four wheels, particularly at high speed.

Shifting battery weight towards the rear of a vehicle can mimic the performance of rear-engine performance vehicles such as the Porsche 911. A rear-wheel drive vehicle with a rear bias will exhibit improved traction and improved acceleration.

In some embodiments, a dynamic, actuated battery compartment may be located either on-center or fore or aft of a vehicle's center, according to a factory setting. A user may choose a software setting that directs the embodiment's algorithm to send signals to motorized actuators that move the battery compartment in response to driving conditions. For example, a driver at a stoplight might opt to apply a command that enables an immediate sensation of sudden acceleration unique to a rear-engine racer such as that of a Porsche 911.

Alternatively, a driver might choose the embodiment's center-engine mode for driving at moderate-to-low speeds. In this case, the embodiment's software directs the battery compartment to relocate to the center of the vehicle (considered the normal factory setting). At each input by the driver, the embodiment's software-controlled actuators shift the batteries toward the rear, center or front of the vehicle. Shifting the batteries fore or aft of the vehicle's center can serve to correct a loss of traction during an aggressive acceleration. A loss of traction in the rear of the vehicle may be met with movement of the battery bank toward the rear, for example.

Similarly, the embodiment enables shifting the batteries to the left or right of the vehicle to counterbalance steering at high speeds.

In one example embodiment, electronic driver inputs enable the adjustment of shock absorbers and suspension components. Suspension components include roll bars, drop links, dampers, ball joints, spherical bearings, rubber bushings, tie rods and the like. In some embodiments, software-controlled suspension is achieved using rheological couplings, in which electric impulses change the stiffness of suspension components. “Droop” refers to the relative softness of a spring or the distance of play between the top and bottom of the spring stroke. Compression refers to the stiffness of a spring between the top and bottom of the spring stroke. Electronically controlled suspension components may also affect drivetrain performance. These electronically controlled components may also dynamically change vehicle caster, camber, toe and alignment so as to drastically change the vehicle performance dynamics. A rheological coupling refers to any movable component having rheological fluid governing the movement of the coupling. The stiffness of movement may be electronically adjusted by altering the charge to the rheological fluid. An eco-mode optimizes range; a comfort mode gives a smooth, compliant suspension; and a high-performance mode enables the necessary traction, acceleration and cornering performance. In an example embodiment, shifting the battery platform rearward can replicate the feel of a rear-engine ICE performance vehicle such as the Porsche 911, simulating its traction, suspension stiffness, rear-wheel drive and other aspects. In some embodiments, the effect of understeer may be imitated with sounds and/or signals that communicate that a rear-engine performance vehicle would likely experience understeer in a given situation without actually putting the driver at risk.

The feel of a brake pedal in ICE cars depends on a number of factors. A common ICE brake system includes a pedal, a booster, a master cylinder, hydraulic lines and calipers. The booster multiplies the force of the brake pedal. The master cylinder converts pressure from the pedal and booster into hydraulic pressure. Variations in the design of the booster, master cylinder, hydraulic lines and calipers affect the feel of a brake pedal. ICE sports cars often have what users call a stiff pedal. A stiff pedal requires minimal movement to begin applying pressure on the calipers for rapid braking. A luxury ICE car may have more “travel,” in which the brake pedal begins applying a small amount of pressure on the calipers with every inch of travel of the pedal. A greater travel in a brake pedal is intended for moderate driving and gradual braking.

Brakes on an EV are effectively switches that send information to electronic brakes. Some EVs have regenerative braking, in which the brake pedal first sends a signal that uses the electric motor as a generator to generate electricity to be stored in the batteries. As more braking power is required, the EV braking system may divert power to brake calipers to decelerate the vehicle. An EV brake may be configured to mimic the stiffness or travel of a performance ICE sports car or luxury car by providing greater or lesser resistance electronically and by reacting differently to the distance that the brake pedal is moved.

Accelerator pedals in ICE vehicles have similar variations in brake pedals. Sports-car models may have an accelerator that responds rapidly under minimal travel, while a luxury car model may accelerate gradually over the course of a longer accelerator travel distance.

A driver may choose a braking or acceleration experience modeled on a specific ICE sports car, in which a stronger pressure on the brake pedal is required for braking, or only light pressure on the accelerator is required for acceleration. In another example a user may choose a performance ICE luxury-car experience in which the brake pedal requires little pressure over long travel, and in which the accelerator responds by gradual acceleration over a long accelerator-travel-stroke.

Embodiments mimic the effects of various vehicles. For example, a replica Porsche 911 circa 1980 embodiment enables the experience of a vehicle that rolls into corners and is quick to oversteer in the event of the throttle being lifted mid-corner. The driver experiences the perceived force of body roll as one would in a Porsche 911.

Another embodiment creates a virtual performance and road feel, with electronic driver inputs enabling the adjustment of shock absorbers, roll bars, dampers and software-controlled suspension and drivetrain performance. An eco-mode optimizes range; a comfort mode gives a smooth, compliant suspension; and a high-performance mode enables necessary traction, acceleration and cornering performance.

In one embodiment, a vehicle manufacturer maps its factory-supported, brand-specific system commands to the algorithms of the method and apparatus to render the EV an immersive ICE simulation that is layered over EV technology. Mapping an audio experience of an ICE performance vehicle may include recording the sound of the engine, transmission, turbo and differential at various speeds under various rates of acceleration and deceleration, in various gears. ICE-performance-vehicle aspects— engine type, number of cylinders, engine volume, turbo settings, transmission type and cabin vibration—and exterior sounds including wind noise and road noise—are all measured and recorded from an actual ICE performance vehicle and input to an algorithm that may be uploaded to the EV CAN. A driver interested in replicating the audio experience of driving a 1960s Jaguar E-Type Roadster might choose to purchase the manufacturer's modified sound system commands specific to that vehicle, or might choose to use the method and apparatus to alter the factory-provided CAN to simulate that audio experience. High-performance ICE vehicles have straight-cut gears that make a distinctive whine-like noise. A driver may choose a specific race car, or may add the racing transmission sound to an existing ICE-performance-vehicle program.

An iteration has additional ICE-related auditory cues, including recorded tire noise, differential noise, turbocharger noise, road noise, transmission noise in each gear, and RPM and wind noise, and accounting for engine type, transmission type and cabin vibration, which is played in the vehicle cabin and responds to actual acceleration. Transmission noise replicates that of an ICE race car's transmission, with the signature whine of straight-cut gears.

All of these auditor cues could be in addition to the ICE drivetrain noises, separate from, or some combination thereof.

Vibratory actuators may include rotary motion in the seat and/or steering wheel. The floor mat of an EV may be programmed to mimic the vibration of an ICE performance vehicle to complement the sound effects. One skilled in the art understands that vibratory actuators may be factory-installed or an after-market installation. Engine and transmission sounds and vibrations may, for example, mimic the sound and feel of the Jaguar Roadster in first gear, as the EV is driven from a stop to 5 mph when the sound and vibration mimic the engine and transmission revving at the same RPM that the Jaguar Roadster would at the same speed in first gear. The shift to second gear may then be mimicked in sound and vibration at the appropriate speed as the driver goes from stop to highway speed; the same might occur in reverse as the driver slows from a given speed to a stop.

Vibration actuators may be configured to perform other functions when not used to create an ICE-performance-vehicle experience. In some embodiments, vibration actuators are configured to augment an EV alert system to alert a driver of an incoming phone call, or to signify that the driver has been driving for a significant number of hours, or the like. This audio experience may be mapped from any number of ICE performance vehicles so that a user may experience classic sports cars like a Porsche 911 or a classic luxury vehicle such as the 1963 Maserati Quattroporte Si, a performance sedan. The audio experience may respond to a driver's style, creating the sound of an aggressively shifted ICE-performance-vehicle when the driver accelerates rapidly, or the sound of downshifting as a driver decelerates rapidly.

Some embodiments mimic the effects of various vehicles. For example, an embodiment creates a virtual visual experience of driving a performance ICE. Modem EVs commonly have large digital touch screens that are used in place of actual gauges, with these screens displaying colored dials on tachometers, speedometers and other gauges, as well as sliding or rotating HVAC controls, switches, indicator lights and the like. This embodiment enables the large electronic screen to mimic that of various performance ICE cars, with their specific controls displayed in 3D digital animation directly on the screen. The apparatus and method enables user customization; for example, one may choose from a set of custom dashboards enabling a choice of gauges in a chosen gauge cluster. Aspects of an ICE performance vehicle are represented by 3D, computer-generated animations that appear as ICE performance-vehicle indicators and actuators. Animations of characteristic changes are reflected in the indicators. For example, actual acceleration generates a 3D animation of a speedometer with a moving needle. Temperature controls are set similarly, with an ICE vehicle's temperature-adjustment lever replicated in 3D animation with haptic controls that a driver touches to move the 3D-animated lever. Driver inputs are sent by software commands to the EV ECU, which directs the CAN to change the temperature accordingly.

In yet another iteration, an EV's exterior is overlaid with an image of a performance ICE car. The image is rendered by rear projection to an LCD coating on the EV's exterior body panels, with the effect of rendering the vehicle's exterior to that of a different car.

The apparatus and method reconfigures aspects of an ICE performance vehicle, enabling driver inputs through a touchscreen on the dashboard or anywhere near the driver's seat. On the touchscreen, a driver may choose ICE performance-vehicle aspects and characteristics to apply. Driver inputs are mapped to existing controls that output those replicating a vehicle model of choice.

Many modern EVs have a built in Heads-Up-Displays (HUDs) to project information on the windshield in a transparent format, allowing the driver to see the road while reading messages about dashboard information, or a notice of a phone call.

In one embodiment, a HUD may project a preferred driving line over the driver's view of the road. A furred line through a turn is projected on a HUD to illustrate where to brake or where to accelerate, all creating a performance-car virtuality while operating safely. When used on an established professional racing track or circuit, the driving lines may be predetermined based on the chosen ICE experience and existing track data. In another example, when driving on a public road, information gathered from a standard EV forward-facing camera, combined with GPS location data, are together used to generate a furred line on a HUD in real time.

The resulting manual driving experience may mimic that of a simulation racing video game while operating under the safety of an electric vehicle's limits. This embodiment may also use holographic gauges for an immersive cockpit effect.

### BRIEF DESCRIPTION OF DRAWINGS

FIG. 1 is a perspective view of a gear shift of the disclosure.

FIG. 2 is a cutaway view of the apparatus of FIG. 1.

FIG. 3 is a perspective view of a clutch pedal of the disclosure.

FIG. 4 is a diagram of a method of using an embodiment of the apparatus.

FIG. 5 is a perspective view of an electric vehicle chassis

FIG. 6 is a detail view of an electric vehicle chassis showing a front suspension assembly.

FIG. 7 is a schematic of a method of an iteration of the disclosure.

FIG. 8 is an illustration of the interior of an EV showing vibratory actuator locations.

FIG. 9 is a perspective view of a performance ICE vehicle dashboard.

FIG. 10 is a perspective view of images of gauges and switches from the performance ICE vehicle dashboard of FIG. 1 on the touch screen and digital screen of an EV.

FIG. 11 is a diagram of a method of using the apparatus of the disclosure.

FIG. 12 is a perspective view of the interior of an electric vehicle showing a heads-up display graphic on a windshield.

FIG. 13 a schematic of a method of the disclosure.

### DETAILED DESCRIPTION

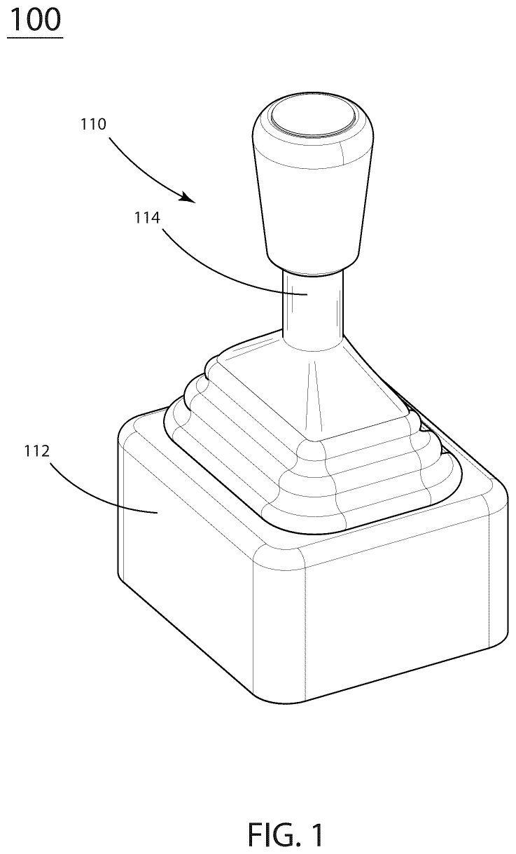

FIG. 1 shows an apparatus of the embodiment 100 with a gear shift 110, a shift lever 114 and a housing 112. The housing 112 has mechanical and electrical components that mimic the feel of an actual gear shift without being connected to an actual transmission. The apparatus 100 is intended to be mounted in an EV in a way that mimics the location of a gear shift in an ICE performance vehicle. One skilled in the art understands that a variety of styles and shapes may imitate specific ICE-performance vehicle gear shifts.

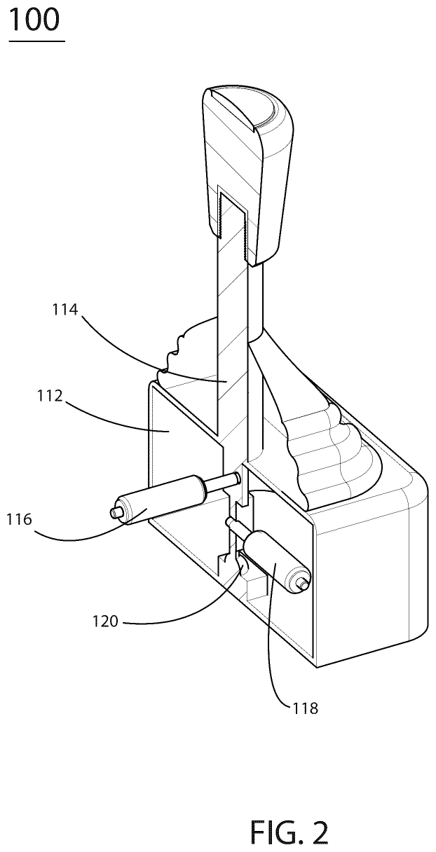

FIG. 2 shows an example embodiment 100 of the electrical and mechanical components in the housing 112 of the gear shift 110. The shift lever 114 is mounted on a pivot 120. A first electro-mechanical actuator 116 controls movement of the shift lever 114 laterally (to the left and right of the user). A second electro-mechanical actuator 118 controls movement of the shift lever 114 fore and aft of the user. In some embodiments electro-mechanical actuators are rheological dampers. One skilled in the art understands that a rheological damper may be controlled by an electrical charge to stiffen or free the movement of the damper in real time. A rheological damper may instantaneously stiffen the movement of the shift lever 114, for example, to imitate the extent of movement so as to mimic the feel of a gear shift in a specific ICE performance vehicle. Furthermore, specific shift patterns can be mimicked by a software-controlled electrical signal. Location of the shift lever 114 is monitored by the extent of the stroke of the electro-mechanical actuators 116, 118 so that the specific location of the shift lever may be determined by a control software. One skilled in the art understands that a variety of electro-mechanical actuators may be employed to control movement of a lever.

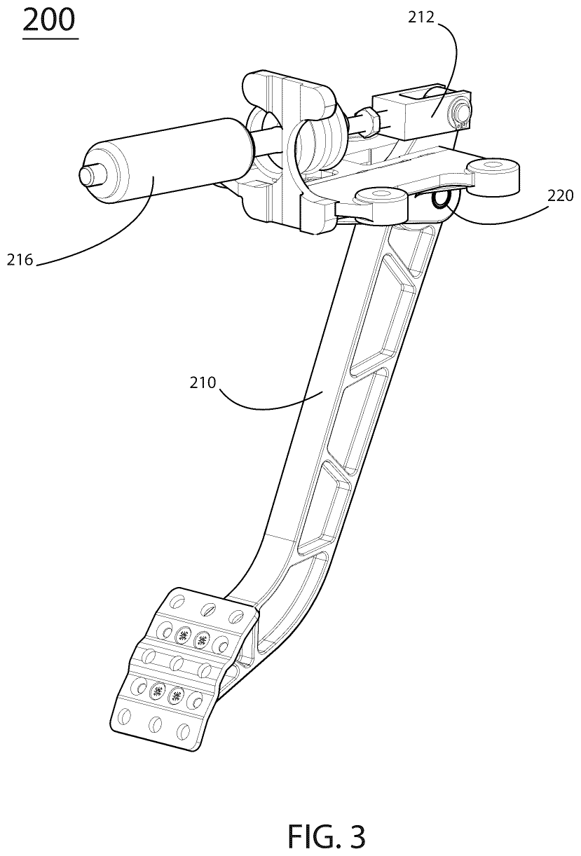

FIG. 3 shows a perspective view of an example embodiment 200 of a clutch pedal 210. The apparatus 200 is intended to be mounted in an EV in a way that mimics the location of a clutch pedal in an ICE performance vehicle. One skilled in the art understands that a variety of styles and shapes may imitate specific ICE performance vehicle clutch pedals. The clutch pedal 210 moves on a pivot 220 and then moves a linkage 212 that moves in the opposite direction of the clutch pedal. An electro-mechanical actuator 216 controls the movement of the linkage 212 and hence the clutch pedal 210. The force required to move the pedal is controlled by electro-mechanical actuator 216 and therefore is able to mimic the amount of force required to move specific clutch pedals from specific ICE performance vehicles. For example, a slight stiffening of the movement of the clutch pedal may be used to mimic the feel of the friction point of a clutch, wherein an actual clutch begins to contact a flywheel. One skilled in the art understands that a variety of electro-mechanical actuators may be employed to control movement of a lever.

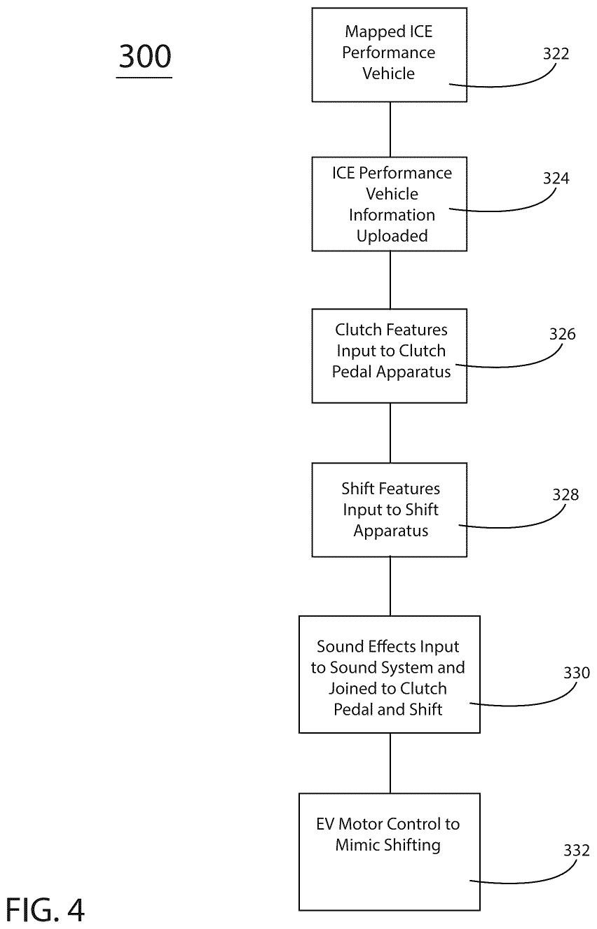

FIG. 4 shows a diagram 300 of a method of using the apparatus of FIG. 1, FIG. 2 and FIG. 3. In this method, ICE performance-vehicle characteristics that relate to clutching and shifting are mapped 322. The stiffness of the clutch movement, the length of the stroke of the clutch, the location of the friction point and the like are measured and recorded. The number of gears, the gear-shift pattern, the distance of movement between gears, and the resistance of the movement of the gear shift are also mapped. The mapped information is stored in the embodiment's software. The mapped ICE-performance vehicle information is uploaded to an EV central control system such as the CAN BUS 324. Clutch features are input to the apparatus 200 (FIG. 3) to set parameters according to the mapped ICE-performance vehicle-clutch characteristics 326. Gear-shift features are input to the apparatus 100 (FIG. 1, 2) to set parameters according to the characteristics of the mapped ICE-performance-vehicle gear shift 328. The embodiment's sound effects communicate with both the clutch and shift components 330. The software further controls the EV motor to control the motor and to mimic the shifting of gears of an ICE transmission, within safe operating limitations. One skilled in the art understands that an electric motor driven at the same speed that the vehicle is traveling may mimic the feel of putting an ICE transmission in neutral, or that down-shifting without braking may be mimicked by using the motor as a generator as when regenerative braking is engaged.

The apparatus and method may influence the control of various systems in the EV. When shifting appropriately for the mimicked ICE, the user may experience the feel of the shift and clutch, the sound of the motor when shifting and accelerating within the range of each gear, and the like. The user may also experience the gear shift not moving when the clutch is not depressed, or the sound of gears grinding in the event of improper clutching and shifting. Within the limits of safety, the apparatus and method may also mimic the feel of a motor stalling if shifting has been done improperly. Electronic controls may reduce power, and intermittently cause the motor vibrate, for example, to mimic the feel of an ICE when shifting into a high gear at an improperly low speed.

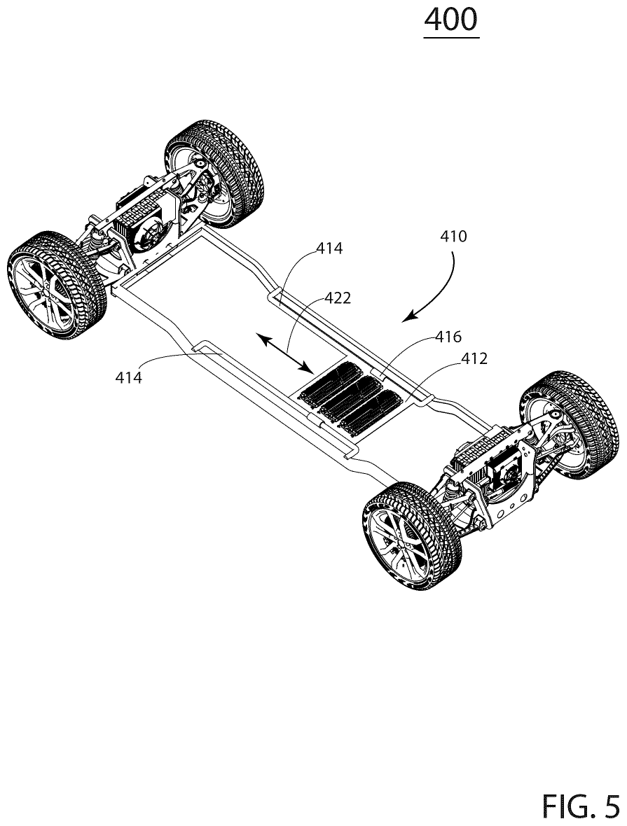

Referring to FIG. 5, an electric vehicle chassis 410 is outfitted with a movable battery bank 412. The battery bank 412 has linear actuators 416 that are coaxial with a track 414, and are configured to move forward and rearward in the vehicle, as represented by arrows 422. Linear actuators are controlled by a program that is configured to mimic specific ICE performance vehicles. The configuration shown, with the battery bank shifted to the forward-most position, is intended to mimic a forward-engine vehicle. By moving the battery bank 412 to the center of the vehicle, a mid-engine vehicle such as a Ferrari 488 GTB can be replicated. In a similar example, the feel of a Porsche 911 may be mimicked by moving the battery bank to the rear-most location, to replicate the feel of driving a rear-engine vehicle.

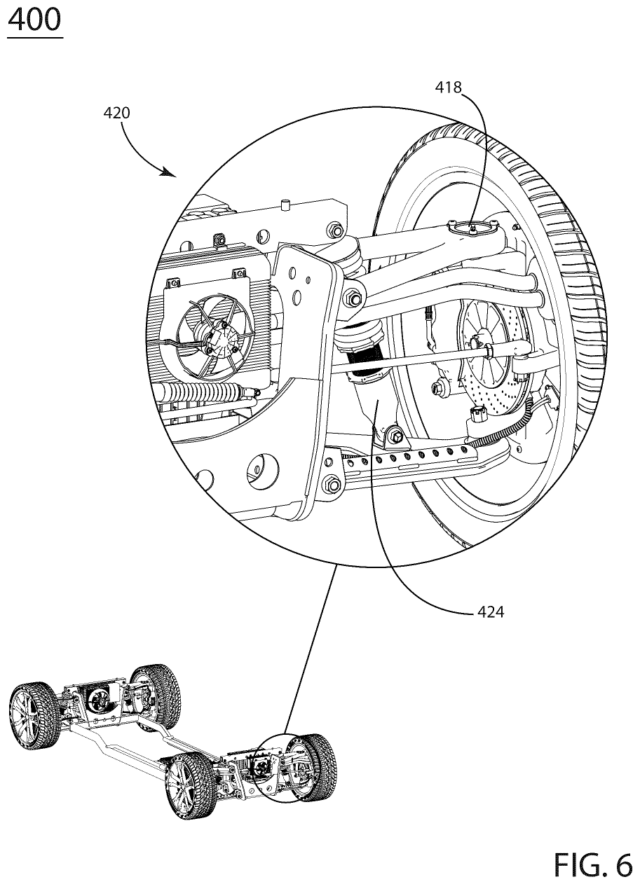

FIG. 6 is a detail view of the suspension assembly 420 of an example electric vehicle. Various components such as a shock absorber 424 and ball joint 418 may be outfitted with electrical components to be instantly adjustable to mimic stiffness and road feel of general or specific ICE performance vehicles. One skilled in the art is familiar with rheological-fluid-motion actuators that can instantaneously adjust between stiff and flexible movement. The stiff suspension of a BMW i8 ICE performance vehicle may be replicated by stiffening a shock 424 and ball joint 418 for example.

A driver who wishes to experience the feel of driving a rear-engine vehicle may choose, for example, the settings associated with a Porsche 911, including the feel of the suspension, to give an immersive driving experience.

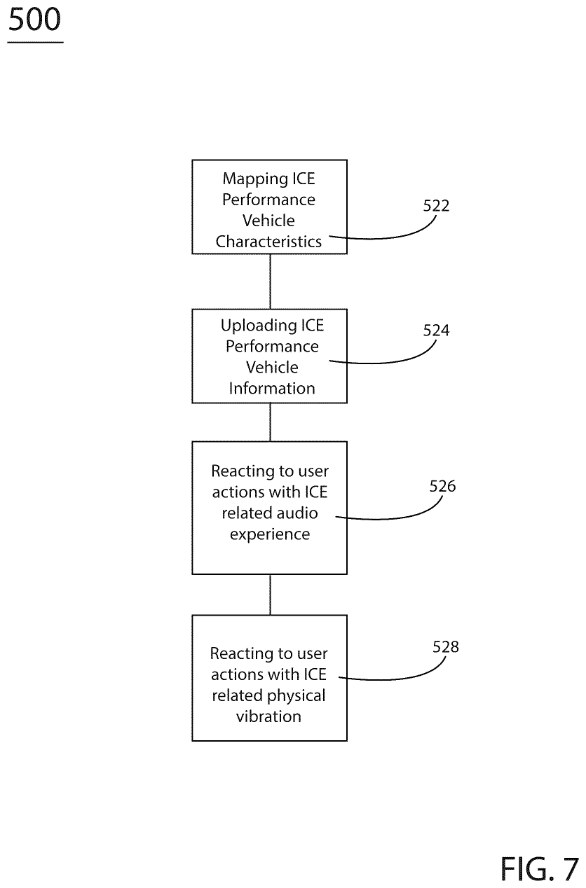

FIG. 7 is a schematic of a method of the disclosure. A method includes mapping ICE-performance-vehicle characteristics 522. These characteristics include recording the sound at different speeds, as well as the relationship between vehicle speed, engine RPM, transmission RPM and each gear, for various acceleration and deceleration rates. Uploading ICE-performance-vehicle information 524 is done by electronically coupling the EV onboard computer system with an internet connection, or another device that holds the mapped information in the form of a software program upgrade, to existing EV software. The uploaded information controls the EV sound system by reacting to user actions to create an ICE-performance-vehicle experience 526. The uploaded information controls EV sound-system components such as a subwoofer to create vibrations throughout the vehicle. The uploaded information also controls the vibratory actuators by reacting to user actions with ICE-related physical vibration 528.

User actions are measured by the software package and are guided by the mapped ICE-performance-vehicle characteristics, and may include determining the acceleration or deceleration rate of the vehicle by measuring change in speed over time. The acceleration or deceleration rate is paired with the sound that a specific ICE performance vehicle would likely make when accelerating at a similar rate. The sound and vibration of the appropriate gear changes, engine, transmission and turbo response to a given acceleration or deceleration rate create a virtual ICE-performance-vehicle experience.

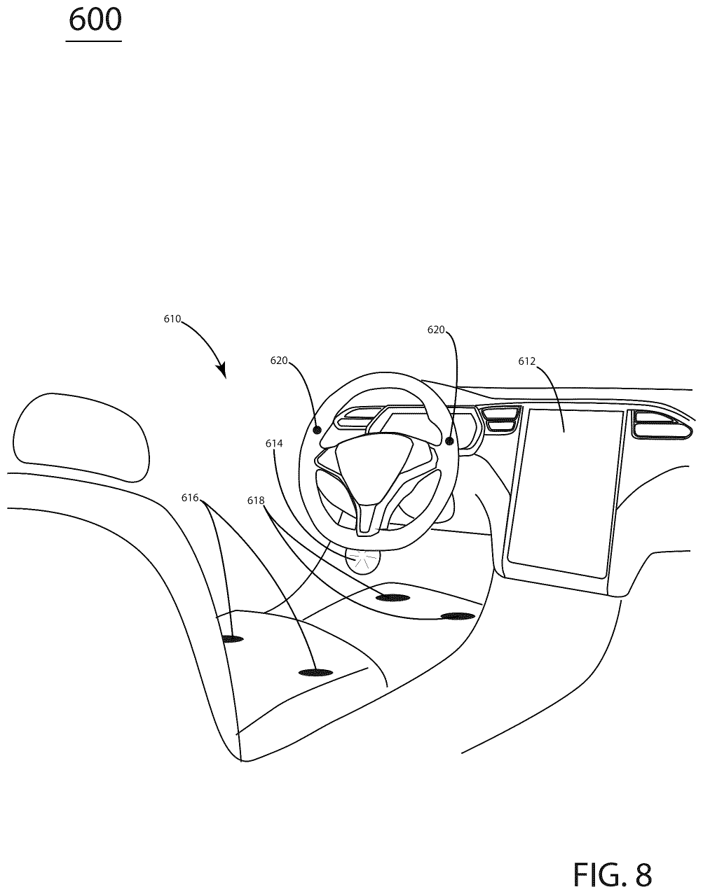

FIG. 8 shows an example EV interior 610. Audio features of the embodiment function through factory-installed EV audio systems, including controls on a touch screen 612 and speakers 614. Vibratory actuators are shown mounted in a seat 616 while others are mounted in the steering wheel 620, and yet others mounted in the floor mat 618. In some embodiments, vibratory actuators are mounted during factory assembly of the vehicle. Factory-mounted vibratory actuators may be employed in the normal use of the vehicle as an alert mechanism. Vibratory actuators may work in conjunction with audio alarms to signify an incoming phone call, an unfastened seat belt, objects in close proximity to the vehicle, and the like. Vibratory actuators may be installed as an aftermarket product in replacement floor mats or seat covers or in a steering-wheel cover in which a wireless connection to the vehicle computer provides communication to vehicle systems that control alarms when not used as part of the audio tactile experience.

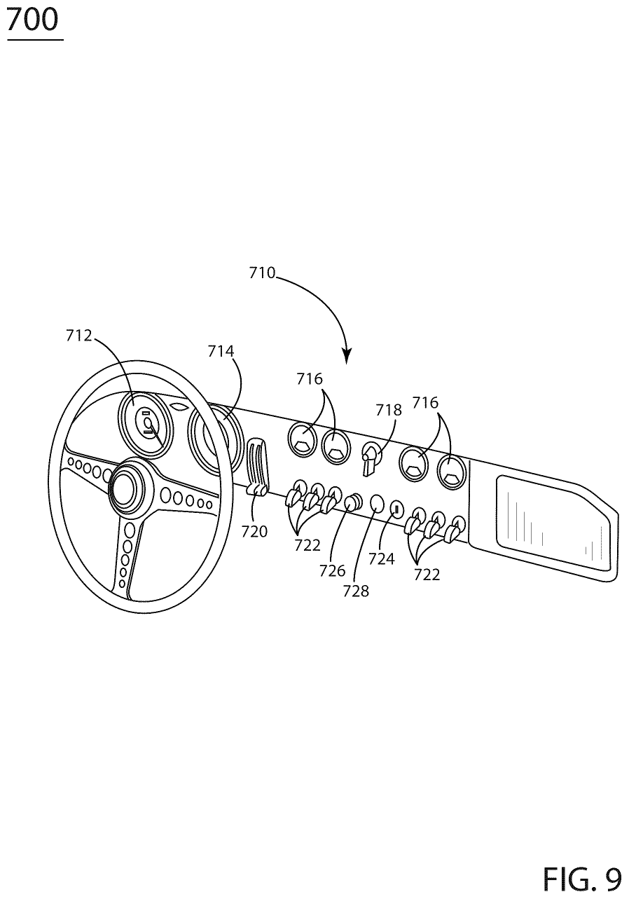

FIG. 9 is a perspective view of an example performance ICE vehicle dashboard 710. This example depicts that of a 1967 Jaguar E-Type roadster. A speedometer 712 is a relatively large, circular analog dial with a radial pointer indicating speed and an analog mileage counter and trip-mileage counter in the center of the dial. A tachometer 714 is of a similar diameter and is also an analog gauge, indicating transmission revolutions per minute (RPM). A sliding lever 720 controls the temperature inside the vehicle by adjusting vents and/or engaging an air conditioner. Gauges 716 are analog gauges that are connected to various sensors that indicate water, oil, fuel, and battery levels. Toggle switches 722 control various features, including windshield-washer fluid spray, interior lights, heating ventilation and cooling-fan speed. An analog dial 718 engages and adjusts headlights and light intensity. Other features on this dashboard include a keyed switch 724 that locks the starter button 726 and a 12V receptacle 728.

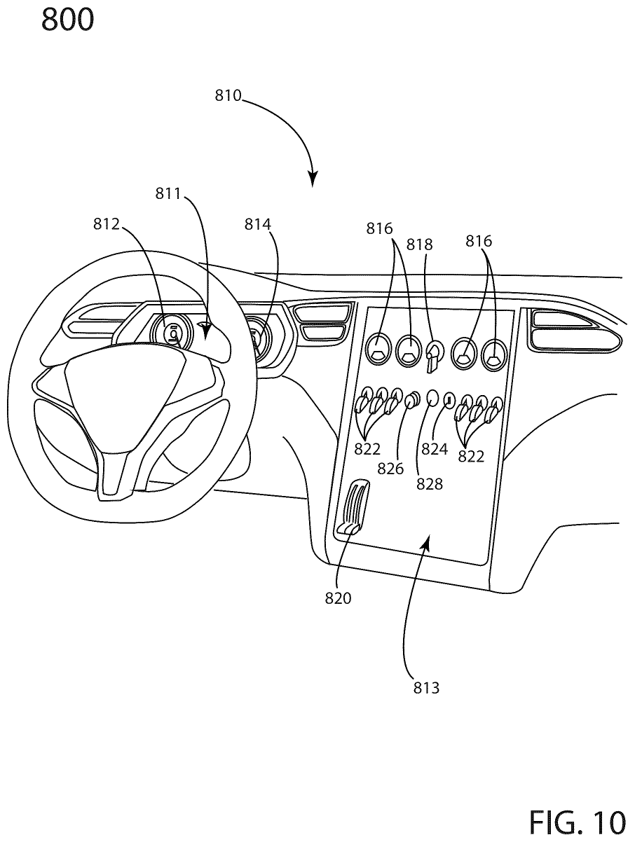

FIG. 10 is a perspective view of an example embodiment 800 of a method and apparatus of illustrating some of the features, gauges and switches on an electric-vehicle dashboard 810. The electric-vehicle dashboard 810 includes a digital screen 811 that illustrates various digital gauges indicating speed, energy level, outside temperature, mileage and the like. In one embodiment the digital screen 811 illustrates a 3D-visual replica of a speedometer 812 that, similar to the speedometer 712 (FIG. 9), is a relatively large, circular analog dial with a radial pointer indicating speed and an analog mileage-counter and trip-mileage counter at the center of the dial. As in the dashboard 710 (FIG. 9) a tachometer 814 is of a similar diameter to the speedometer 812 and is also a 3D model similar in appearance to the tachometer 714. In this embodiment the tachometer indicates the revolutions per minute (RPM) of the EV motor. In some embodiments the tachometer indicates the RPM that an ICE transmission would generate at a given speed, assuming gear-shifting were done appropriately. One skilled in the art understands that a sound system may be configured to approximate the sound of an ICE transmission shifting through gears at various speeds.

A touch screen 813 is common to many EVs. An EV touch screen usually illustrates buttons and slider bars that enable users to control the vehicle interior climate: music, navigation, and other aspects. The touch screen projects realistic 3D renderings of ICE performance-type analog gauges. Such gauges 816 may indicate, for example, water, oil, fuel, and battery levels, labeling from left to right. In some embodiments, gauges 816 may indicate energy level, efficiency, miles remaining at current driving speed, and the like. A 3D digital rendering of the headlight control switch 818 may be operated by sliding a finger over the control to move the animation to control the EV headlights. In some embodiments, 3D renderings of analog switches 822 may act as slider bars to control windshield-washer fluid spray, interior lights, heating, ventilation and cooling-fan speeds and the like, as well as a 3D animation of analog levers 820, which function as slider bars to control the EV interior temperature. In this example embodiment, the keyed switch 824 and the starter button 828 may function together to start the EV. One skilled in the art understands that these may be configured to function only when a key fob is in proximity of the vehicle. One skilled in the art understands that the 12V input 826 may be reconfigured for another useful purpose, such as turning on a dome light.

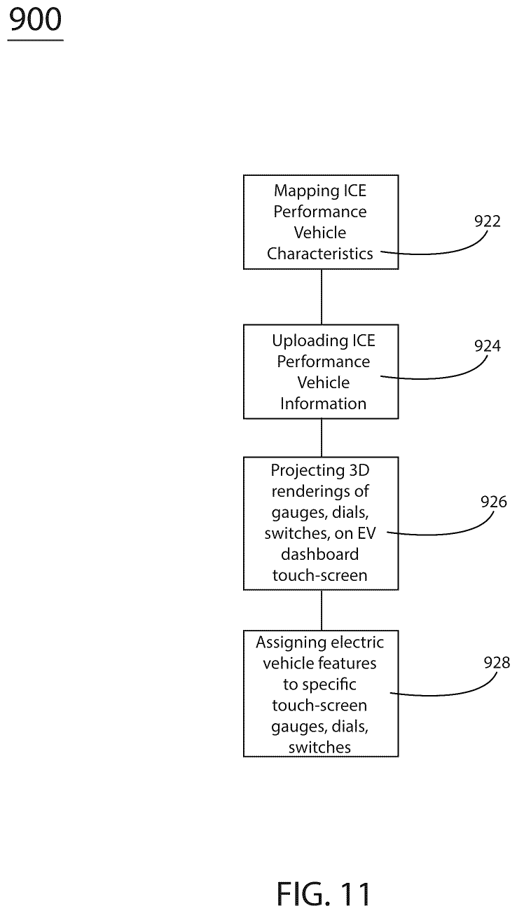

FIG. 11 is a flowchart of the method of the disclosure. An example method of the embodiment maps ICE-performance vehicle characteristics 922 to user inputs. Recorded aspects of the ICE-performance vehicle come embedded in the embodiment's software. Uploading ICE performance-vehicle information 924 provides the EV CAN with the 3D graphics that simulate the dashboard features and functions of an ICE performance vehicle. Projecting 3D renderings of gauges, dials, switches and the like on an EV dashboard touch screen 926 gives the user the look and feel of an ICE-performance-vehicle environment. Assigning electric-vehicle features to specific touch-screen illustrations of gauges, dials, switches 928 and the like enables a user to still control the necessary features and to read the necessary gauges while experiencing the look and feel of an ICE performance vehicle.

In another embodiment, LCD surfaces are adhered to the body panels of the EV. 3D-rendered images of an ICE performance vehicle are displayed on the LCD surfaces wherein each ICE performance vehicle body panel is displayed on the corresponding EV body panel to provide an exterior visual experience of an ICE performance vehicle.

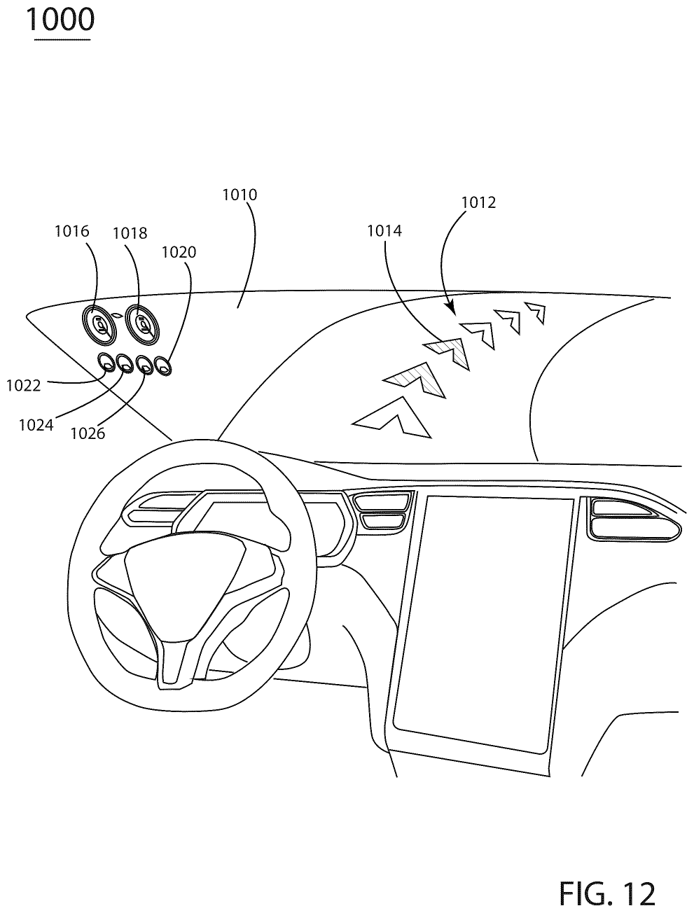

FIG. 12 is a perspective view of the interior of an electric vehicle showing heads-up display graphics on a windshield 1010. A racing line 1012 denotes the optimal line for driving through a curve. One skilled in the art understands that on public roads such a feature would produce a line that keeps a driver safely in a lane. The racing line may change color 1014 to indicate optimal locations for slowing or braking. For example, a yellow segment of a racing line may indicate an optimal location to ease off the accelerator, and a red line segment may indicate an optimal location to brake.

In some embodiments, a software program is configured to gather information from an EV's onboard cameras and sensors to derive information that is projected through the HUD onto the windshield 1010 in the style and graphics used in auto racing. For example, a performance ICE vehicle speedometer 1016 may depict an animated moving needle showing vehicle speed in MPG or KmPH.

Additional information common to performance ICE vehicles configured for racing may also be projected. In an example embodiment, traction is measured and projected 1020. One skilled in the art understands that current EV onboard computers are capable of measuring wheel RPM, and of calculating circumference distance vs. speed to determine whether wheels are slipping. In another example, energy level 1022 may be projected in a graphic style that mimics a performance-ICE-vehicle gas gauge. In another example, images of gauges like those in performance ICE vehicles may display a rate of acceleration, outside temperature, tire pressure and other metrics in place of an ICE oil-pressure gauge or water-temperature gauge. One skilled in the art understands that the gauges may be reassigned, as an EV does not have oil or water coolant to measure.

In another example, an ICE-style tachometer 1018 is projected through the HUD. Although there is no need for a tachometer 1018 in an EV, one skilled in the art understands that the tachometer may show an increase up to a given speed normally associated with first gear, and then a decrease followed by an increase up to a given speed normally associated with second gear, and so on. In yet other embodiments, ICE engine, turbocharger and transmission sounds are played through the EV sound system following the movement of the tachometer.

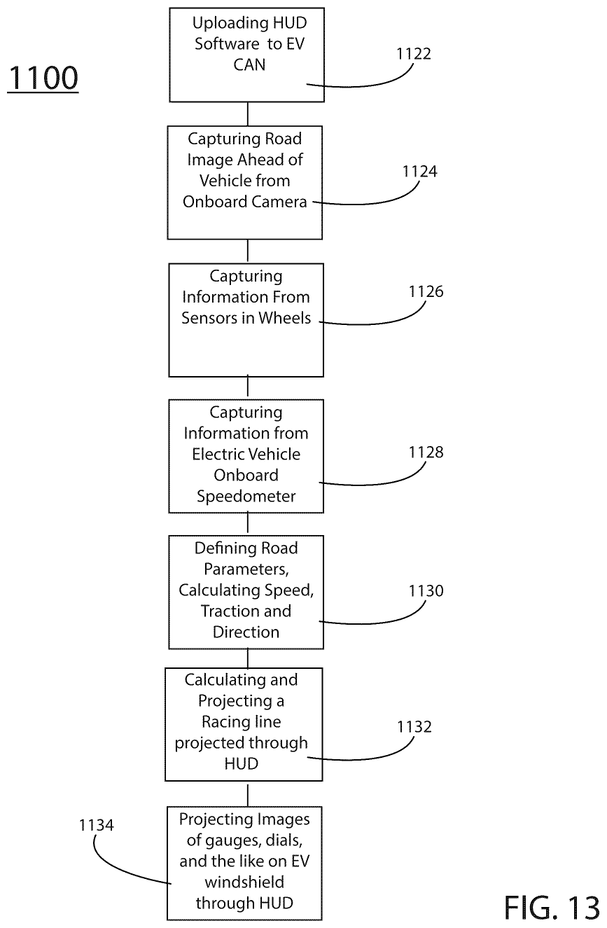

FIG. 13 is a schematic of the method of the disclosure 1100. A software program configured to interface with an EV's onboard cameras and sensors is uploaded to the EV CAN 1122, and directs the EV HUD. The software captures a road image from the EV onboard camera 1124. Sensors proximal to the wheels of the EV measure rotational velocity of each wheel 1126. The speed of the vehicle is measured by the EV onboard speedometer 1128. The information gathered and measured is used to calculate speed, traction and direction 1130. One skilled in the art understands that the rotational velocity of each wheel, as well as the direction of the vehicle and the direction of a turn in the road, may be used to calculate the traction or slippage of each wheel. The information gathered is used to inform the software program, which then calculates a racing line along the road ahead and projects the racing line 1132 on the EV windshield through the heads-up display.

Images of gauges, dials, and the like are projected on the EV windshield through the EV HUD 1134. In some embodiments the gauges, dials and the like are rendered images of gauges and dials from ICE performance vehicle dashboards.

1. An apparatus for mimicking the operation of an internal-combustion-engine vehicle in an electric vehicle, the apparatus comprising:
a software protocol configured to engage at least one onboard sensor in said electric vehicle; and
to configure a response to said at least one sensor; and
to communicate said response in the form of sensory stimuli to a driver of said electric vehicle.

2. The apparatus of claim 1 further comprising:
a gear shift in said electric vehicle, electronically coupled to an electric vehicle electronic control unit, and further electronically coupled with a controller-area network; wherein
movement of said gear shift sends signals through said electronic control unit to said controller-area network to control aspects of said electric vehicle dynamics that mimic internal-combustion-vehicle transmission dynamics.

3. The apparatus of claim 2 further comprising:
a first actuator movably engaged with said gear shift along a first axis; and
said actuator provides resistance and guidance to mimic the feel of moving a gear shift in the internal-combustion-engine transmission.

4. The apparatus of claim 3 further comprising:
a second actuator movably engaged with said gear shift along a second axis, wherein the first axis is perpendicular to the second axis; wherein
said actuators mimic the play and engagement of internal-combustion-engine transmission gear-shifts.

5. The apparatus of claim 4 wherein:
said first and second actuators are configured to create vibration to mimic the internal-combustion-engine transmission when mis-shifted, so as to mimic gear grinding when improper shifting has occurred.

6. The apparatus of claim 2 wherein:
the apparatus is coupled with the electric vehicle controller-area network to control a sound system in said electric vehicle to mimic the sound of said internal-combustion-vehicle-transmission transitions from a low end of a gear to a high end of a gear.

7. The apparatus of claim 2 wherein:
the apparatus is coupled with the electric vehicle controller-area network to control an electric motor and a sound system in said electric vehicle to mimic the torque curve and sound of said internal-combustion-vehicle transmission as it transitions from a low end of a gear to a high end of a gear.

8. The apparatus of claim 2 wherein:
the apparatus is coupled with the electric vehicle controller-area network to control an electric motor and a sound system in said electric vehicle to mimic the horsepower curve and sound of said internal-combustion-vehicle transmission as it transitions from a low end of a gear to a high end of a gear.

9. The apparatus of claim 2 wherein:
the apparatus is coupled with the electric vehicle controller-area network to control at least one motor in said electric vehicle to provide relatively less torque after movement of said gear shift and relatively greater torque as speed increases after movement of said gear shift.

10. The apparatus of claim 2 further comprising:
an after-market gear shift configured to be mounted in said electric vehicle having a shift lever pivotably engaged with a housing; and
electronic measurement equipment configured to track movement of said after-market gear shift is electronically coupled to, and sends signals through, the electronic-vehicle-electronic-control unit and is further electronically coupled with the electric vehicle controller area network; wherein
the after-market gear shift sends signals to the sound system of the electric vehicle to produce the sound of shifting an internal-combustion-engine transmission.

11. The apparatus of claim 10 wherein:
said after-market gear shift is electronically coupled to said electronic control unit by way of OBD-II.

12. The apparatus of claim 10 wherein:
said after-market gear shift is electronically coupled to said electronic control unit by way of Bluetooth connectivity.

13. The apparatus of claim 10 wherein:
when not in use to mimic shifting an internal-combustion-engine transmission, the apparatus is coupled with the electric vehicle controller-area network to enable a user to set the control of features and functions of the electric vehicle depending on the position of the gear shift.

14. The apparatus of claim 10 further comprising:
a first actuator movably engaged with said gear shift along a first axis; and
a second actuator movably engaged with said gear shift along a second axis, wherein the first axis is perpendicular to the second axis; and
each actuator provides resistance and guidance to mimic the feel of moving a gear shift in the internal-combustion-engine transmission.

15. The apparatus of claim 10 wherein:
said after-market shifter further functions to shift the gears of the electric vehicle.

16. The apparatus of claim 14 wherein:
said first actuator and said second actuator provide resistance to mimic the action of pushing down on the shifter to access a reverse gear.

17. The apparatus of claim 10 further comprising:
said gear shift is generally movable in an H-pattern.

18. The apparatus of claim 10 wherein:
said actuators are configured to provide varying resistance to give haptic feedback to mimic the free movement and physical engagement of gears found in certain internal-combustion-engine transmissions.

19. The apparatus of claim 10 further comprising:
a linkage pivotally engaged with a clutch pedal, configured to be mounted proximal to accelerator and brake pedals in an electric vehicle, and
electronic measurement equipment configured to track movement of said clutch pedal is electronically coupled to, and sends signals through, the electric-vehicle electronic control unit, and is further electronically coupled to the electric-vehicle controller area network; wherein
movement of said clutch pedal sends signals through said electronic control unit to said controller-area network to control aspects of the electric vehicle functions.

20. The apparatus of claim 19 further comprising:
the apparatus is coupled with the electric vehicle controller-area network to control a sound system in said electric vehicle to mimic the sound of shifting gears in an internal combustion engine manual transmission, according to movement of the clutch pedal.

21. The apparatus of claim 19 further comprising:
a clutch actuator movably engaged with said linkage along a first axis; and
said actuator provides resistance to mimic the resistance of a similar clutch pedal in an internal-combustion-engine transmission when depressing said clutch, and vibration when releasing said clutch.

22. The apparatus of claim 19 further comprising:
said actuator provides resistance to mimic the free movement and engagement point of a similar clutch pedal in the internal-combustion-engine transmission.

23. The apparatus of claim 19 further comprising:
the linkage is coupled with the electric vehicle controller-area network to enable a user to set the control of features and functions of the electric vehicle, depending on the position of the clutch pedal.

24. The apparatus of claim 1 further comprising:
an electric vehicle chassis; and
a track fixedly engaged with a frame of said electric vehicle; and
a battery compartment movably engaged with said track; wherein
said battery compartment may be moved from front, to mid, to rear of the electric vehicle to mimic the effect of a front-engine, mid-engine, and rear-engine vehicle performance.

25. The electric vehicle chassis of claim 24 further comprising:
linear-motion actuators fixedly engaged with said battery compartment and movably engaged with said track and electrically coupled with an electronic control unit within said electric vehicle; wherein
movement of said battery compartment is controlled by software uploaded to said electronic control unit.

26. An electric vehicle chassis comprising:
electronically adjustable suspension components in the suspension assembly of the electric vehicle;
wherein
roll bars may be adjusted to stiffen or loosen movement of each roll bar to mimic the road-feel of an ICE performance vehicle.

27. The electric vehicle chassis of claim 26 wherein:
ball joints may be adjusted to stiffen or loosen movement of each ball joint to mimic the road feel of an ICE performance vehicle.

28. The apparatus of claim 26 further comprising:
electronically adjustable shock absorbers in the suspension assembly of the electric vehicle; wherein
said shock absorbers may be adjusted to stiffen or loosen movement of each shock absorber to mimic the road feel of an ICE performance vehicle.

29. The apparatus of claim 28 wherein:
said shock absorbers are each a rheological coupling.

30. The apparatus of claim 28 wherein:
suspension components in the suspension assembly of the electric vehicle are electronically adjustable;
wherein
electronically adjustable suspension components dynamically change vehicle caster, camber, toe and alignment to alter the vehicle performance dynamics.

31. The electric vehicle chassis of claim 30 wherein:
suspension components are rheological couplings.

32. A method for using the apparatus of claim 24, the method comprising:
providing a referenced internal combustion-engine vehicle dynamic definition; and
providing a baseline electric-vehicle dynamics definition; and
modifying the electric-vehicle baseline vehicle-dynamics definition to match an internal-combustion-engine vehicle dynamics definition.

33. The method of claim 32 further comprising:
providing a battery pack movably engaged with a track; and
providing said track fixedly engaged with a frame of said electric vehicle; and
changing the center of gravity of the electric vehicle by moving the battery pack about the track.

34. The method of claim 32 further comprising:
modifying the electric vehicle baseline vehicle dynamics definition by electronically controlling suspension components to match the vehicle alignment of an internal-combustion-engine vehicle alignment.

35. The method of claim 32 further comprising:
modifying the electric vehicle baseline vehicle-dynamics definition by electronically controlling suspension components to match the vehicle droop and compression of an internal-combustion-engine vehicle alignment.

36. The method of claim 35 further comprising:
electronically controlling suspension components to match droop and compression of an internal-combustion-engine vehicle; and
adjusting actively to road conditions.

37. The method of claim 35 further comprising:
electronically controlling suspension components to match droop and compression of an internal-combustion-engine vehicle; and
adjusting static vehicle weight balance to the referenced internal combustion vehicle dynamic definition.

38. The method of claim 32 further comprising:
electronically controlling a motor in said electric vehicle to match engine-torque-curve parameters of an internal-combustion-engine vehicle.

39. The method of claim 38 further comprising:
utilizing torque-vectoring, individual wheel braking and acceleration to mimic internal-combustion-engine-vehicle dynamics.

40. The method of claim 32 further comprising:
electronically controlling a motor in said electric vehicle to match engine horsepower curve parameters of an internal-combustion-engine vehicle.

41. The method of claim 32 further comprising:
adjusting electric-vehicle-steering ratio to match steering-ratio parameters of an internal-combustion-engine vehicle.

42. The method of claim 32 further comprising:
adjusting electric-vehicle-steering weight to match steering-weight parameters of an internal-combustion-engine vehicle.

43. The method of claim 32 further comprising:
adjusting electric-vehicle-steering-assist parameters to match steering-assist parameters of an internal-combustion-engine vehicle.

44. The method of claim 32 further comprising:
adjusting electric-vehicle-steering-lock to lock parameters to match steering lock to those of an internal-combustion-engine vehicle.

45. The apparatus of claim 1 further comprising:
a software compatible with and able to be uploaded to an electric-vehicle-control computer, including a mapping of the audio experience of an internal-combustion-engine performance vehicle; wherein
said software uses the electric vehicle sound system to play the sound of an internal-combustion-engine performance vehicle in response to user actions in the electric vehicle.

46. The apparatus of claim 45 wherein:
said software is includes sounds mapped from a specific internal-combustion-engine performance vehicle; and
said software applies said sounds created by given actions performed in said internal combustion performance vehicle to similar actions performed in said electric vehicle.

47. The apparatus of claim 45 further comprising:
vibratory actuators in communication with the cockpit of said electric vehicle; wherein
said vibratory actuators provide vibration, controlled by said software, to mimic vibrations in said internal-combustion-engine performance vehicle when given actions are performed, according to similar actions performed in said electric vehicle.

48. The apparatus of claim 47 wherein:
the vibratory actuator is a subwoofer/vibratory actuator.

49. The apparatus of claim 47 wherein:
eccentric-rotating-mass motor vibratory actuators fixedly engaged with the steering wheel of said electric vehicle; wherein
said vibratory actuators provide vibration, controlled by said software, to mimic vibrations in said internal-combustion-engine performance vehicle when given actions are performed, according to similar actions performed in said electric vehicle.

50. The apparatus of claim 47 further comprising:
eccentric-rotating-mass-motor-vibratory actuators fixedly engaged with the floor of said electric vehicle; wherein
said vibratory actuators provide vibration, controlled by said software, to mimic vibrations in said internal-combustion-engine performance vehicle when a given user action is performed, according to a similar action performed in said electric vehicle.

51. A method for using the apparatus of claim 45 wherein:
mapping audio characteristics of an internal combustion performance vehicle; and
writing a software package including said audio characteristics; and
uploading said software to an electric vehicle controller-area network system; and
playing said audio characteristics through an audio system connected to said vehicle controller-area network system in said electric vehicle in response to user actions in said electric vehicle.

52. The method of claim 51 wherein:
the audio system provides an audio experience to the interior of the electric vehicle.

53. The method of claim 51 wherein:
the audio system provides an audio experience to the exterior of the electric vehicle.

54. The method of claim 51, said mapping further comprising:
recording audio of said internal-combustion-performance vehicle driven in each gear of at least one speed and rate of acceleration; and
playing said audio when said electric vehicle is driven at the speed that is in the range of said each gear at said at least one rate of acceleration.

55. The method of claim 51, said mapping further comprising:
recording audio of a turbocharger of said internal-combustion-performance vehicle at least one speed and rate of acceleration, and playing said audio through said audio system connected to said vehicle controller-area network.

56. The method of claim 51, said mapping further comprising:
recording audio of a differential of said internal combustion performance vehicle at at least one speed and rate of acceleration; and playing said audio through said audio system connected to said vehicle controller area network.

57. The method of claim 51, said mapping further comprising:
recording audio of a transmission of said internal combustion performance vehicle at least one speed and rate of acceleration; and playing said audio through said audio system connected to said vehicle controller area network.

58. The method of claim 51, said mapping further comprising:
recording audio of tire noise of said internal combustion performance vehicle at least one speed and rate of acceleration; and playing said audio through said audio system connected to said vehicle controller area network.

59. The method of claim 51, said mapping further comprising:
recording audio of wind noise of said internal combustion performance vehicle at least one speed, and playing said audio through said audio system connected to said vehicle controller-area network.

60. The method of any of claims 54-59, further comprising:
matching actual speed and rate of acceleration in said electric vehicle to specific sounds associated with the speed and rate of acceleration in an ICE performance vehicle recorded sounds.

61. A method of using the apparatus of claim 1 further comprising:
mapping ICE-performance-vehicle characteristics relating to dashboard indicators and actuators; and
creating computer-generated, 3D-rendered animations of said dashboard indicators and actuators; and
uploading ICE-performance-vehicle characteristics relating to dashboard indicators and actuators and said 3D-rendered animations thereof to an EV electronic control unit; and
displaying said 3D-rendered animations on said EV interior screens; and
assigning actions of 3D-rendered animations to EV characteristics relating to dashboard indicators and actuators; wherein
engaging said 3D-rendered animations on said EV screens performs functions of said indicators and actuators.

62. The method of claim 61 wherein:
the ICE-performance-vehicle characteristics relating to dashboard indicators and actuators are derived from a specific ICE vehicle make, model and year.

63. The method of claim 1 wherein:
the ICE-performance-vehicle characteristics relating to dashboard indicators and actuators are chosen by the user from a collection of ICE performance vehicles.

64. The method of claim 63 wherein:
dashboard indicators chosen by the user may be assigned electric vehicle functions by the user.

65. The method of claim 61 further comprising:
engaging said 3D-rendered animations on a heads-up display configured to perform functions of said indicators and actuators.

66. A method for using the apparatus of claim 1, the method comprising:
mapping ICE performance-vehicle dashboard characteristics relating to dashboard indicators and actuators; and
creating computer-generated, 3D-rendered animations of said dashboard, including said indicators and actuators; and
uploading ICE-performance-vehicle characteristics relating to dashboard indicators and actuators and said 3D-rendered animations thereof to an EV electronic-control unit; and
providing a holographic generator; and
displaying said 3D-rendered animations through said holographic generator proximal to said EV interior screens; and
assigning actions to 3D-rendered animations to EV characteristics relating to dashboard indicators and actuators; wherein
engaging said 3D-rendered holographic animations proximal to said EV screens performs functions of said indicators and actuators.

67. A method for using the apparatus of claim 1, the method comprising:
mapping ICE performance-vehicle exterior image of each of an example ICE performance vehicle body panel; and
creating computer-generated, 3D-rendered images of each of said body panel; and
uploading computer-generated, 3D-rendered images to an EV electronic control unit; and
providing LCD surfaces on each electric vehicle body panel; and
displaying said 3D-rendered images to each corresponding electric vehicle body panel; wherein an image of an ICE performance vehicle is projected over the exterior surface of the electric vehicle.

68. The apparatus of claim 1 further comprising:
a heads-up display; and
an onboard camera configured to capture a road ahead of the electric vehicle; and
at least one sensor electronically coupled to the vehicle; and
a software program configured to gather information from said onboard camera and said at least one sensor; wherein
the software program defines the parameters of the road ahead of the electric vehicle and the dynamic condition so the vehicle calculates a racing line along the road ahead of the electric vehicle; wherein
the racing line is projected onto a windshield of the electric vehicle by the heads-up display.

69. The apparatus of claim 68 wherein:
said software program further gathers information from said onboard camera to identify other vehicles on said road ahead of the electric vehicle to calculate an ideal passing line around said other vehicles;
wherein
said passing line is based on calculations of road conditions and vehicle dynamic parameters.

70. The apparatus of claim 68 wherein:
said heads-up display further provides notification of required steering inputs in a graphical manner.

71. The apparatus of claim 68 wherein:
said heads-up display provides notifications of required acceleration and deceleration inputs in a graphical manner.

72. The apparatus of claim 68 wherein:
the software program compares vehicle speed and the rotational velocity of each wheel to determine if wheels are slipping; wherein
the racing line is altered to indicate a need for altered steering and braking to provide an ideal driving experience.

73. The apparatus of claim 68 further comprising:
the software program configured to gather information from the electric vehicle onboard speedometer; and
an image of a speedometer reflecting said information, projected onto the windshield of the electric vehicle through the heads-up display.

74. The apparatus of claim 73 wherein:
the image of the speedometer is an image of an ICE-performance-vehicle speedometer.

75. The apparatus of claim 68 further comprising:
the software program configured to gather information from the electric vehicle onboard battery meter; and
an image of a battery meter that is projected onto the windshield of the electric vehicle through the heads-up display.

76. The apparatus of claim 75 wherein:
the image of the battery meter is an image of an ICE-performance-vehicle gas gauge.

77. The apparatus of claim 68 further comprising:
the software program configured to gather information from the electric vehicle onboard temperature gauge; and
an image of inside and outside temperature is projected onto the windshield of the electric vehicle through the heads-up display.

78. The apparatus of claim 77 wherein:
the image of the temperature gauge is an image of an ICE-performance-vehicle temperature gauge.

79. A method of performing the functions of the apparatus of claim 68, the method comprising:
uploading heads-up display software to electric vehicle controller-area network; and
capturing road images ahead of vehicle from an onboard camera; and
capturing information from sensors in communication with the vehicles; and
defining road parameters including speed, traction and direction; and
calculating and projecting a racing line through the heads-up display.

80. The method of claim 79 further comprising:
projecting images of electric vehicle gauges through the heads-up display.

81. The method of claim 80 wherein:
the images of electric vehicle gauges mimic the appearance of ICE-performance-vehicle gauges.
